(19) United States
(12) Patent Application Publication
(10) Pub. No.: US 2025/0311653 A1
(43) Pub. Date: Oct. 9, 2025

(54) SCARIFIER

(71) Applicant: Ricky Robichaud, Shediac Cape (CA)

(72) Inventor: Ricky Robichaud, Shediac Cape (CA)

(21) Appl. No.: 18/630,297

(22) Filed: Apr. 9, 2024

(51) Int. Cl. A01B 33/10; A01B 33/12

(52) U.S. Cl. CPC A01B 33/106; A01B 33/12

(57) ABSTRACT

A scarifier for raking and loosening soil includes a frame having a base plate and configured to rotate about a central axis, a rod coupled to the base plate and arranged centrally to the base plate and extending in an axial direction and adapted to be inserted inside the soil to support the scarifier and at least one tool coupled to the base plate and configured to extend inside the soil to loosen the soil.

### BACKGROUND OF THE INVENTION

The present disclosure relates, generally, to a soil working equipment, and more particularly to a scarifier that may be connected to an equipment for example, a seed sowing machine to assist in raking and loosening the soil.

Scarifier is a type of farming or soil working equipment used for loosening soil. To achieve a desirable scarifying effect during scarifying process, the traditional scarifier may strike/hit the root systems of different crops present at different depths of the land due to lack of restriction in depth of penetration of the scarifier, causing a decline in living matters and leaves the soil to erosion through wind and water. This negative impact on the soil will eventually influence the growth of subsequent crops.

### SUMMARY OF THE INVENTION

According to an aspect of the disclosure, a scarifier for raking and loosening soil is disclosed. The scarifier includes a frame having a base plate and configured to rotate about a central axis, a rod coupled to the base plate and arranged centrally to the base plate and extending in an axial direction and adapted to be inserted inside the soil to support the scarifier and at least one tool coupled to the base plate and configured to extend inside the soil to loosen the soil.

In some additional, alternative, or selectively cumulative embodiments, the scarifier further includes a rod holder attached to base plate and facilitates a removable coupling of the rod with the base plate.

In some additional, alternative, or selectively cumulative embodiments, the scarifier further includes at least one first stopper coupled to the rod and the rod holder and arranged between the rod holder and the rod to restrict a depth of penetration of the rod inside the soil.

In some additional, alternative, or selectively cumulative embodiments, the scarifier further includes at least one second stopper coupled to the frame and adapted to be arranged at a plurality of positions to control a depth of insertion of the at least one tool inside the soil.

In some additional, alternative, or selectively cumulative embodiments, the at least one second stopper is adapted to be displaced in a vertical direction to arrange the at least one stopper at any desired position out of the plurality of positions.

In some additional, alternative, or selectively cumulative embodiments, the scarifier further includes at least one bracket attached to the base plate to facilitate a removable coupling of the at least one tool to the base plate.

In some additional, alternative, or selectively cumulative embodiments, the frame includes a wall extending vertically from an outer edge to define a compartment to store a material to be discharged inside the soil during the soil loosening.

In some additional, alternative, or selectively cumulative embodiments, the scarifier further includes a handle attached to the frame to enable a user to lift the scarifier.

In accordance with an embodiment of the disclosure, a scarifier for raking and loosening soil is disclosed. The scarifier includes a frame having a base plate and configured to rotate about a central axis, a rod coupled to the base plate and arranged centrally to the base plate and extending in an axial direction and adapted to be inserted inside the soil to support the scarifier, at least one tool coupled to the base plate and configured to extend inside the soil to loosen the soil and at least one stopper coupled to the frame to restrict a depth of insertion of at least one of the rod or the at least one tool inside the soil.

In some additional, alternative, or selectively cumulative embodiments, the scarifier further includes a rod holder attached to base plate and facilitates a removable coupling of the rod with the base plate.

In some additional, alternative, or selectively cumulative embodiments, the at least one stopper includes at least one first stopper coupled to the rod and the rod holder and arranged between the rod holder and the rod to restrict a depth of penetration of the rod inside the soil.

In some additional, alternative, or selectively cumulative embodiments, wherein the at least one stopper includes at least one second stopper coupled to the frame and adapted to be arranged at a plurality of positions to control a depth of insertion of the at least one tool inside the soil.

In some additional, alternative, or selectively cumulative embodiments, the at least one second stopper is adapted to be displaced in a vertical direction to arrange the at least one stopper at any desired position out of the plurality of positions.

In some additional, alternative, or selectively cumulative embodiments, the scarifier further include at least one bracket attached to the base plate to facilitate a removable coupling of the at least one tool to the base plate.

In some additional, alternative, or selectively cumulative embodiments, the frame includes a wall extending vertically from an outer edge to define a compartment to store a material to be discharged inside the soil during the soil loosening.

In some additional, alternative, or selectively cumulative embodiments, the scarifier further includes a handle attached to the frame to enable a user to lift the scarifier.

### BRIEF DESCRIPTION OF FIGURES

FIG. 1 illustrates a front perspective view of a scarifier, in accordance with an embodiment of the disclosure;

FIG. 2 illustrates a bottom perspective view of a bottom portion of the scarifier of FIG. 1, in accordance with an embodiment of the disclosure;

FIG. 3 illustrates a front schematic view of the scarifier of FIG. 1, in accordance with an embodiment of the disclosure; and

FIG. 4 illustrates an exploded schematic view of the scarifier of FIG. 1, in accordance with an embodiment of the disclosure.

### DETAILED DESCRIPTION

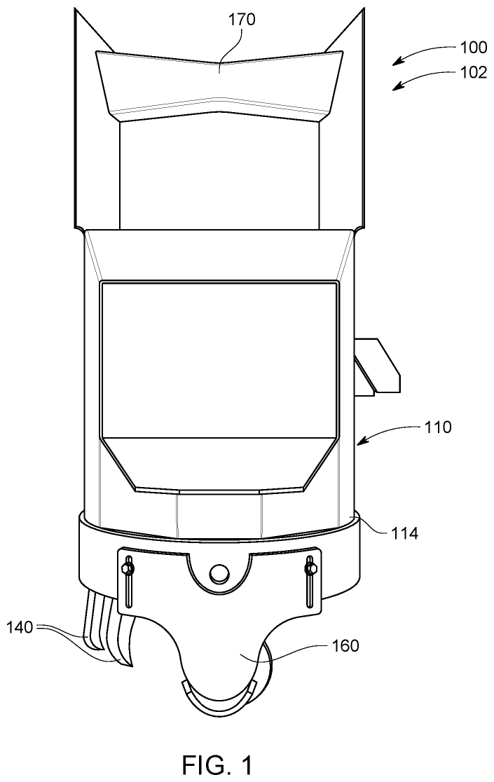

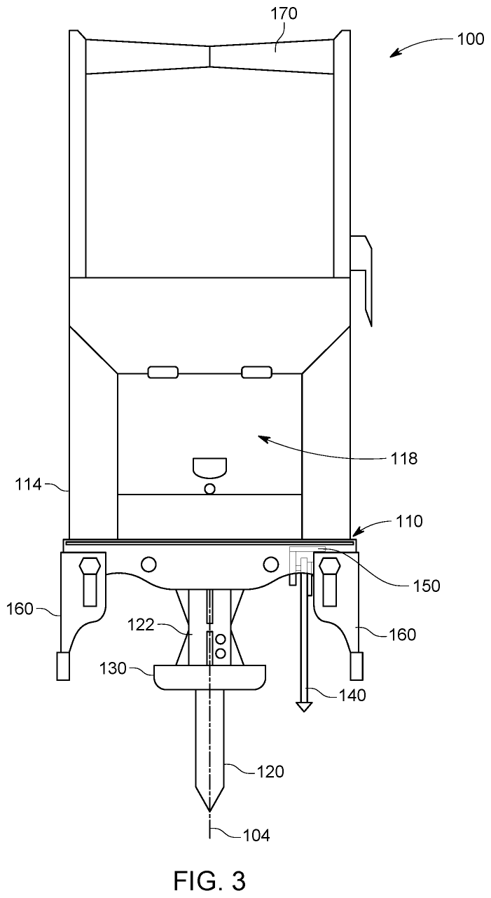

Referring to FIGS. 1 to 4, a soil working equipment 100, for example, a scarifier 102, to break up the topsoil of a garden/an agricultural land is shown. The scarifier 102 is adapted to be connected to a machine, for example, a seed sowing machine, to assist in raking and loosening the soil for preparing a suitable condition of soil for seed sowing. Further, the scarifier 102 is rotated around a central axis 104 by the machine to enable the loosening and raking of the soil.

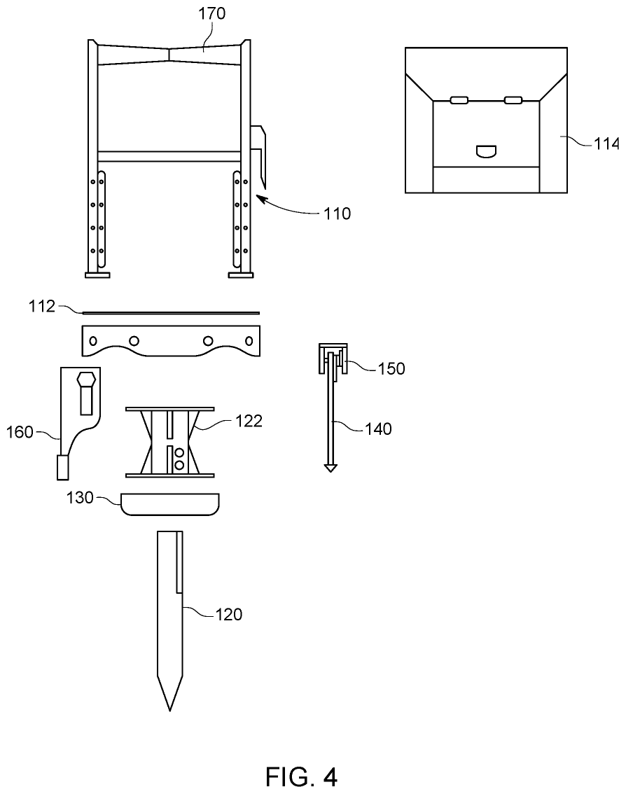

As shown in FIG. 1 and FIG. 4, the scarifier 102 includes a frame 110 having a base plate 112 and at least one wall 114 extending vertically from the base plate 112 and along an outer edge 116 of the base plate 112. The frame 110 acts as a support base to which various components of the scarifier 102 are mounted. In the illustrated embodiment, the base plate 112 is a substantially circular disc and the at least one wall is single wall extending vertically from the outer edge 116 and arranged circularly around the central axis 104. Accordingly, the wall 114 defines a cylindrical shape and defines a compartment 118 to store one or more material. In some embodiments, the scarifier 102 may include a conduit (not shown) extending from the compartment 118 and downwardly of the base plate 112 through the base plate 112. The conduit may be fluidly connected to a container arranged inside the compartment 118 and having the material to enable the flow of the material from the container to the soil during soil loosening or raking process.

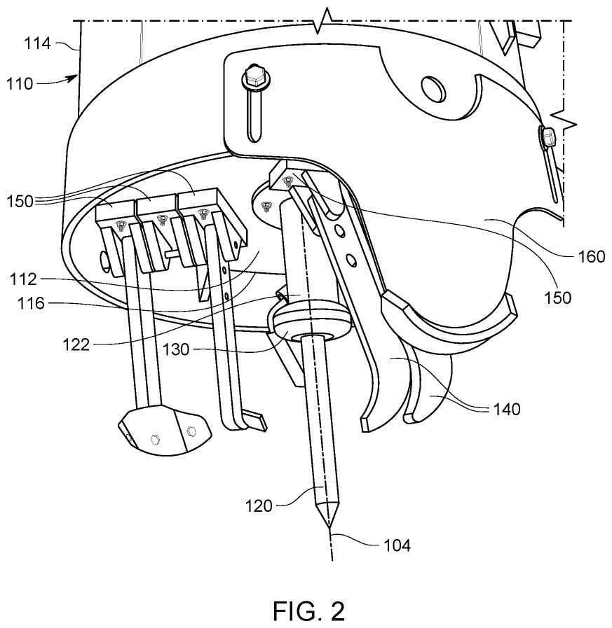

Further, the scarifier 102 includes a rod 120 extending in an axial direction, along the central axis 104, from the base plate 112 and coupled to the base plate 112. The rod 120 is arranged substantially central to the base plate 112 and extends in a direction opposite to the direction of the extension of the wall 114 from the base plate 112. The rod 120 is arranged to be inserted inside the soil to provide a support to the scarifier 102 during an operation of the scarifier 102 to perform loosening or raking of the soil. To couple the rod 120 to the base plate 112, the scarifier 102 includes a rod holder 122 attached to the base plate 112, and the rod 120 is removably attached to the rod holder 122. Further, a stopper 130, for example, a first stopper 130, is arranged at an end of the rod holder 122 and extends circularly around the rod 120. As shown in FIG. 2, the rod 120 extends inside the rod holder 122 through the first stopper 130, and the first stopper 130 prevents the insertion of the rod 120 inside the soil beyond a certain limit.

Moreover, the scarifier 102 includes at least one tool 140 attached to the base plate 112 and extending in a direction of the extension of the rod 120 from the base plate 112. The at least one tool 140 may be arranged between the rod holder 122 and the outer edge 116 of the base plate 112 in a radial direction and is adapted to be inserted inside the soil to loosen the soil. To enable a removable engagement of the at least one tool 140 with the base plate 112, the scarifier 102 includes at least one bracket 150 attached to the base plate 112. The bracket 150 facilitates the attachment of more than one type of tools to the base plate 112.

Further, to control the insertion of the tool 140 inside the soil to a plurality of depths, the scarifier 102 includes at least one second stopper 160 attached to the wall 114 or the base plate 112 and adapted to be displaced vertically relative to the frame 110 and adapted to be arranged between a plurality of positions corresponding to the plurality of depths. Accordingly, to limit the insertion of the tool 140 up to a desired depth inside the soil, the second stopper 160 is displaced to an associated position and locked to the associated position. Accordingly, the second stopper 160 prevents the insertion of the tool 140 inside the soil beyond the desired depth corresponding to the position. Further, the scarifier 102 may include a handle 170 extending to facilitate a user to lift the scarifier 102 lifting and movement of the scarifier.

It should be understood that the foregoing description is only illustrative of the aspects of the disclosed embodiments. Various alternatives and modifications can be devised by those skilled in the art without departing from the aspects of the disclosed embodiments.

1. A scarifier for raking and loosening soil, the scarifier comprising:
a frame having a base plate and configured to rotate about a central axis;
a rod coupled to the base plate and arranged centrally to the base plate and extending in an axial direction and adapted to be inserted inside the soil to support the scarifier; and
at least one tool coupled to the base plate and configured to extend inside the soil to loosen the soil.

2. The scarifier of claim 1 further comprises a rod holder attached to base plate and facilitates a removable coupling of the rod with the base plate.

3. The scarifier of claim 2 further comprises at least one first stopper coupled to the rod and the rod holder and arranged between the rod holder and the rod to restrict a depth of penetration of the rod inside the soil.

4. The scarifier of claim 1 further comprises at least one second stopper coupled to the frame and adapted to be arranged at a plurality of positions to control a depth of insertion of the at least one tool inside the soil.

5. The scarifier of claim 4, wherein the at least one second stopper is adapted to be displaced in a vertical direction to arrange the at least one stopper at any desired position out of the plurality of positions.

6. The scarifier of claim 1 further comprises at least one bracket attached to the base plate to facilitate a removable coupling of the at least one tool to the base plate.

7. The scarifier of claim 1, wherein the frame includes a wall extending vertically from an outer edge to define a compartment to store a material to be discharged inside the soil during the soil loosening.

8. The scarifier of claim 1 further comprises a handle attached to the frame to enable a user to lift the scarifier.

9. A scarifier for raking and loosening soil, the scarifier comprising:
a frame having a base plate and configured to rotate about a central axis;
a rod coupled to the base plate and arranged centrally to the base plate and extending in an axial direction and adapted to be inserted inside the soil to support the scarifier;
at least one tool coupled to the base plate and configured to extend inside the soil to loosen the soil; and
at least one stopper coupled to the frame to restrict a depth of insertion of at least one of the rod or the at least one tool inside the soil.

10. The scarifier of claim 9 further comprises a rod holder attached to base plate and facilitates a removable coupling of the rod with the base plate.

11. The scarifier of claim 10, wherein the at least one stopper includes at least one first stopper coupled to the rod and the rod holder and arranged between the rod holder and the rod to restrict a depth of penetration of the rod inside the soil.

12. The scarifier of claim 9, wherein the at least one stopper includes at least one second stopper coupled to the frame and adapted to be arranged at a plurality of positions to control a depth of insertion of the at least one tool inside the soil.

13. The scarifier of claim 12, wherein the at least one second stopper is adapted to be displaced in a vertical direction to arrange the at least one stopper at any desired position out of the plurality of positions.

14. The scarifier of claim 9 further comprises at least one bracket attached to the base plate to facilitate a removable coupling of the at least one tool to the base plate.

15. The scarifier of claim 9, wherein the frame includes a wall extending vertically from an outer edge to define a compartment to store a material to be discharged inside the soil during the soil loosening.

16. The scarifier of claim 9 further comprises a handle attached to the frame to enable a user to lift the scarifier.
